(19) United States
(12) Patent Application Publication
(10) Pub. No.: US 2026/0322530 A1
(43) Pub. Date: Oct. 15, 2026

(54) PROTECTING AGAINST DATA CORRUPTION IN HIGH-BANDWIDTH ETHERNET

(71) Applicant: Cisco Technology, Inc., San Jose, CA (US)

(72) Inventors: Adee Ofir Ran, Maayan Baruch (IL); Benson Menacherry Sunny, Bangalore (IN); Liron Sheffer Spitzer, Ein Vered (IL)

(73) Assignee: Cisco Technology, Inc., San Jose, CA (US)

(21) Appl. No.: 19/299,653

(22) Filed: Aug. 14, 2025

Related U.S. Application Data
(60) Provisional application No. 63/787,106, filed on Apr. 11, 2025.

(51) Int. Cl. H04L 1/00

(52) U.S. Cl. CPC H04L 1/0045; H04L 1/0061

(57) ABSTRACT

In various implementations, a device obtains Ethernet-transmitted data. The device provides the Ethernet-transmitted data to a decoder. The device identifies, using the decoder, an uncorrectable codeword in the Ethernet-transmitted data. The device marks, using the decoder, all blocks in the Ethernet-transmitted data associated with the uncorrectable codeword and two or more subsequent blocks in the Ethernet-transmitted data as erroneous.

### RELATED APPLICATIONS

This application claims priority to U.S. Provisional Application No. 63/787,106, filed Apr. 11, 2025, and entitled “PROTECTING AGAINST DATA CORRUPTION IN HIGH-BANDWIDTH ETHERNET” by Ran, et al., the contents of which are incorporated herein by reference.

### TECHNICAL FIELD

The present disclosure relates generally to computer networks, and, more particularly, to protecting against data corruption in high-bandwidth Ethernet.

### BACKGROUND

Ethernet standards in recent years, such as 800GBASE-R (800 Gb/s Ethernet) and 1.6TBASE-R (1.6 Tb/s Ethernet), have extended Ethernet to support very high-bandwidth communications. This added bandwidth can be useful in many network deployments, including data centers, artificial intelligence (AI) inference and training fabrics, and other deployments that exhibit high bandwidth loads.

However, at these higher bandwidths, an observation herein is that the definitions of the Ethernet physical coding sublayer (PCS) can cause data corruption. This data corruption also cannot be mitigated against using techniques such as forward error correction (FEC). In general, FEC operates by sending redundant data as part of a communication to allow the receiver to piece together the full message, even if some of the data is lost or otherwise corrupted during transmission. The probability of such corruption is low, but non-negligible, and was not expected when the PCS standard was created.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate examples of the block distributions for 800GBASE-R and 1.6GBASE-R;

FIGS. 4A-4B illustrate examples of unmarked error scenarios for both 800GBASE-R and 1.6TBASE-R;

FIGS. 5A-5B illustrate examples of protecting against data corruption in high-speed Ethernet; and

FIG. 6 illustrates an example procedure for protecting against data corruption in high-speed Ethernet, in accordance with the teachings herein.

### DESCRIPTION OF EXAMPLE EMBODIMENTS

### Overview

According to one or more embodiments of the disclosure, a device obtains Ethernet-transmitted data. The device provides the Ethernet-transmitted data to a decoder. The device identifies, using the decoder, an uncorrectable codeword in the Ethernet-transmitted data. The device marks, using the decoder, all blocks in the Ethernet-transmitted data associated with the uncorrectable codeword and two or more subsequent blocks in the Ethernet-transmitted data as erroneous.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

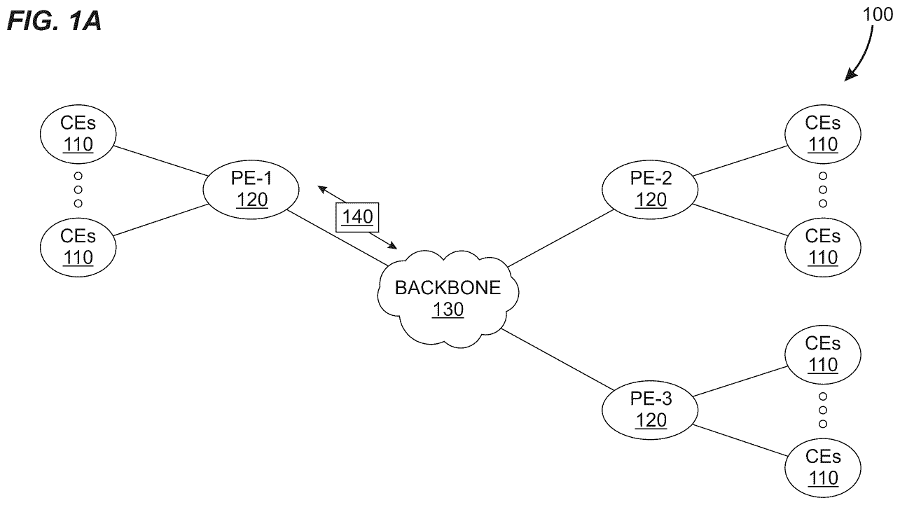

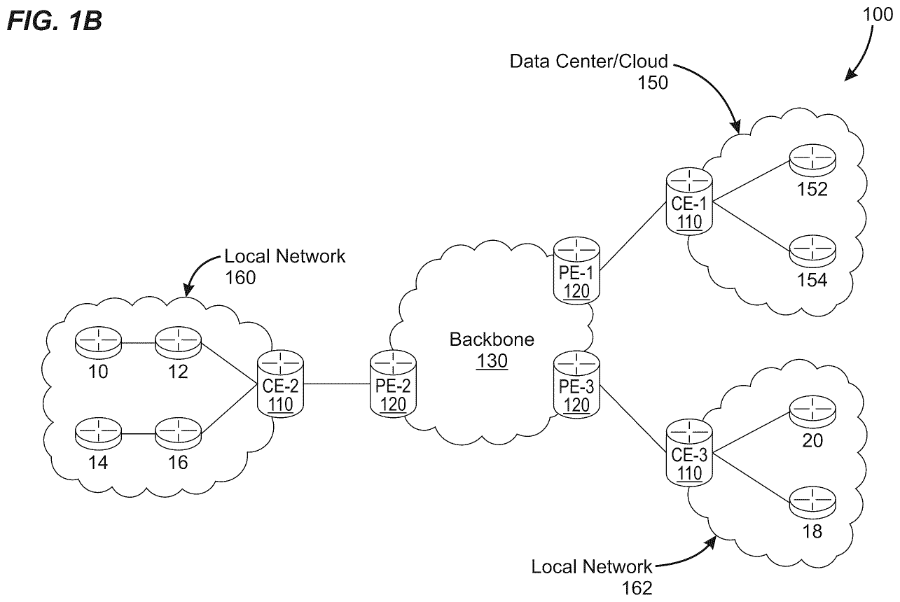

FIG. 1A is a schematic block diagram of an example network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160-162 that include devices/nodes 10-16 and devices/nodes 18-20, respectively, as well as a data center/cloud environment 150 that includes servers 152-154. Notably, local/branch networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local/branch network 160, local/branch network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local/branch network 160 to router CE-1 at the edge of data center/cloud environment 150 over an MPLS or Internet-based service provider network in network backbone 130. Similarly, a second tunnel may also connect these routers over a 4G/5G/LTE cellular service provider network. SD-WAN techniques allow the WAN functions to be virtualized, essentially forming a virtual connection between local/branch network 160 and data center/cloud environment 150 on top of the various underlying connections. Another feature of SD-WAN is centralized management by a supervisory service that can monitor and adjust the various connections, as needed.

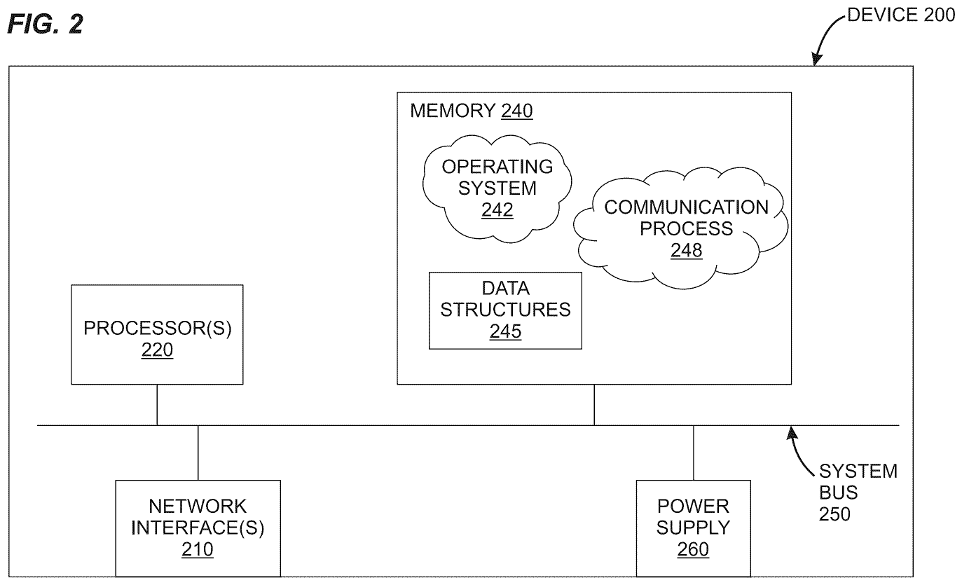

FIG. 2 is a schematic block diagram of an example node/device 200 (e.g., an apparatus) that may be used with one or more implementations described herein, e.g., as any of the devices shown in FIGS. 1A-1B above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s), such as network 100. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a communication process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

As would be appreciated, the Physical Coding Sublayer (PCS) is a protocol sublayer of the physical layer (PHY) used in various Ethernet standards such as Fast Ethernet, Gigabit Ethernet, Terabit Ethernet and the like. For instance, clause 172 of the Institute of Electrical and Electronic Engineers (IEEE) 802.3df-2024 standard for 800 Gb/s Ethernet defines its PCS and clause 175 of the IEE P802.3dj draft standard for 1.6 Tb/s Ethernet defines its PCS. These PCSs have common characteristics, including
Two instances of an earlier PCS definition (clause 119), each of which includes two forward error correction (FEC) decoders
Scrambling, with a self-synchronizing descrambler (defined in clause 49)
Stateless block decoder, defined in clause 172 as an alternative to the earlier decoder of clause 119 (originally also from clause 49)

The combination of the “double PCS,” the self-synchronizing scrambler, and the stateless decoder creates a potential for unmarked errors, when the FEC decoder encounters an uncorrectable codeword, and possible data corruption. More specifically, the combination of the elements above creates a potential for unmarked errors when the FEC decoder encounters an uncorrectable codeword, which can cause false packet acceptance (FPA), a scenario that was not recognized during development of P802.3dj. Although the probability of this occurring is low, it is not enough to be negligible and could affect communications post-deployment.

### Protecting Against Data Corruption in High-Bandwidth Ethernet

The techniques herein introduce an approach that protects against data corruption in high-speed Ethernet deployments that would otherwise by caused by an FEC decoder encountering an uncorrectable codeword. In various implementations, the techniques herein may do so to address packet truncation that can result from a stateless decoder.

Illustratively, the techniques described herein may be performed by hardware, software, and/or firmware, such as in accordance with communication process 248, which may include computer executable instructions executed by the processor 220 (or independent processor of communication interfaces 210) to perform functions relating to the techniques described herein.

Specifically, according to various implementations, a device obtains Ethernet-transmitted data. The device provides the Ethernet-transmitted data to a decoder. The device identifies, using the decoder, an uncorrectable codeword in the Ethernet-transmitted data. The device marks, using the decoder, all blocks in the Ethernet-transmitted data associated with the uncorrectable codeword and two or more subsequent blocks in the Ethernet-transmitted data as erroneous.

Before delving into the approaches introduced herein, a few observations are made respect to the current standardization efforts for Ethernet, such as the PCS definitions for both 800GBASE-R and 1.6TBASE-R.

More specifically, the PCS definition for 800GBASE-R splits communications into two flows of 400GBASE-R, each with its own scrambler and descrambler. Even and odd blocks under this setup go through separate scramblers.

Likewise, the 1.6TBASE-R PCS also specifies the use of two flows, this time with each flow being 800G and having its own scrambler and descrambler. Note that the block distribution before the scramblers is different from that of 800GBASE-R.

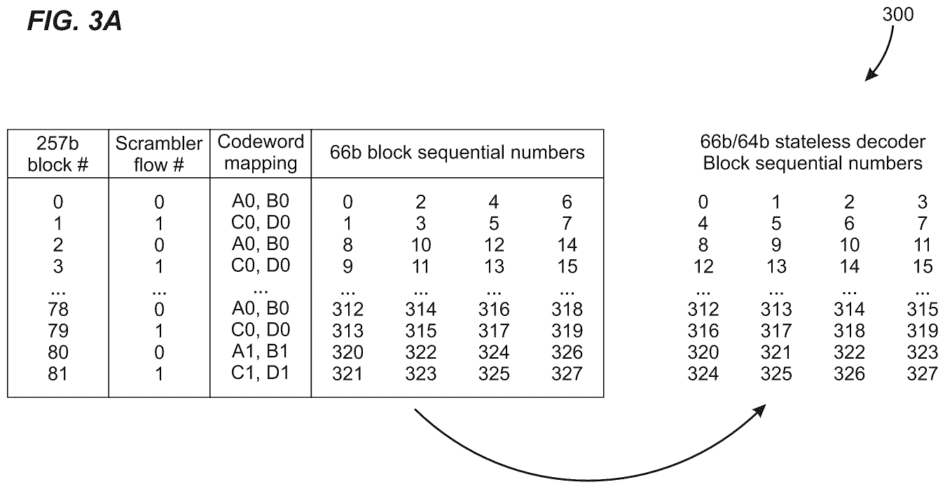

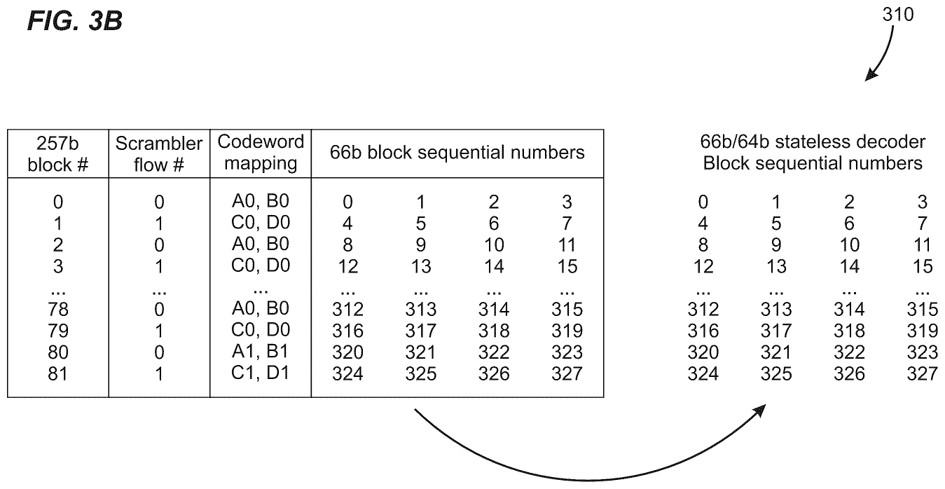

FIGS. 3A-3B illustrate examples of the block distributions for both 800GBASE-R and 1.6GBASE-R, respectively. As shown in example 300 in FIG. 3A, the PCS of 800GBASE-R reorders the blocks from the 257b reverse transcoding to create the order shown on the right. Similarly, example 310 in FIG. 3B shows that the PCS of 1.6TBASE-R reorders the blocks from the 257b reverse transcoding to create the order shown on the right.

Error marking in the PCS for both 800GBASE-R and 1.6TBASE-R takes the same approach by leveraging a Reed-Solomon decoder in each of the two flows. In both instances, the Reed-Solomon decoder operates by processing the codeword to extract the symbols of the message, making any needed corrections, and discarding the parity symbols. It is able to correct combinations of up to t=15 symbol errors in the codeword and, if unable to correct an error, indicate that the error was uncorrected. The probability of a codeword having t+1, t+2, etc. uncorrected errors is not expected to exceed 10⁻¹⁶.

In the case of a codeword including an uncorrectable error, both 800GBASE-R and 1.6TBASE-R take the approach whereby the decoder notifies the PCS receive function to set every 66-bit block within the associated two codewords to an error block (EBLOCK_R). To do so, the synchronization header is set to 11 for all of the 66-bit blocks created by the 256B/257B to 64B/66 transcoder from these codewords.

One observation is that each input bit error creates two additional bit errors, at the 39^{th} and 58^{th} subsequent bits, due to the descrambler. This is because the descrambler reverses the operation of the scrambler according to the following: G (x)=1+x³⁹+x⁵⁸. As a consequence, the descrambler can multiply the error.

Another observation herein is that more recent standards, such as 800GBASE-R and 1.6TBASE-R, now rely on a stateless decoder, while prior PCS specifications used a state-diagram decoder. This stateless decoder generally operates by generating 800GMII transfers based on the preceding and current 66-bit blocks. The stateless decoder then decodes each 66-bit block to a 72-bit vector according to a set of predefined rules. However, unlike the state-diagram decoder, the stateless decoder does not check the sequences of blocks. Instead, it only creates an additional error block after every input block identified as an error.

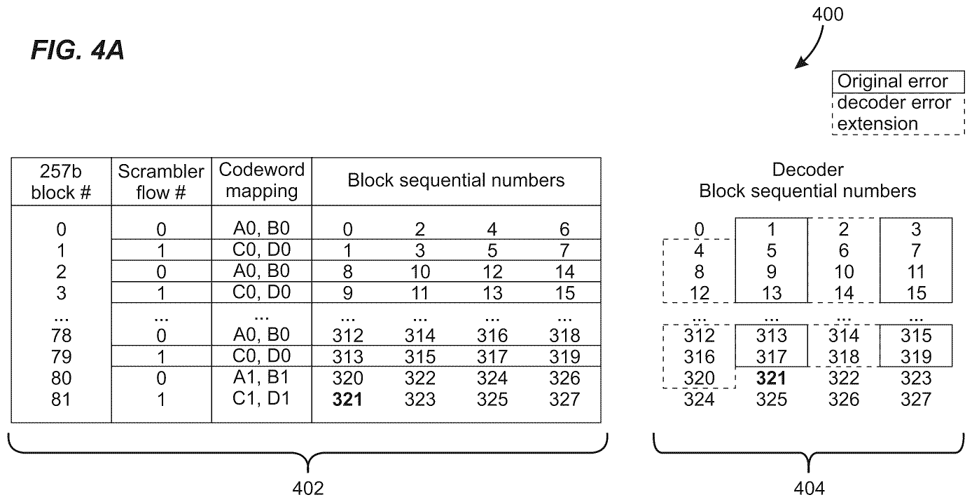

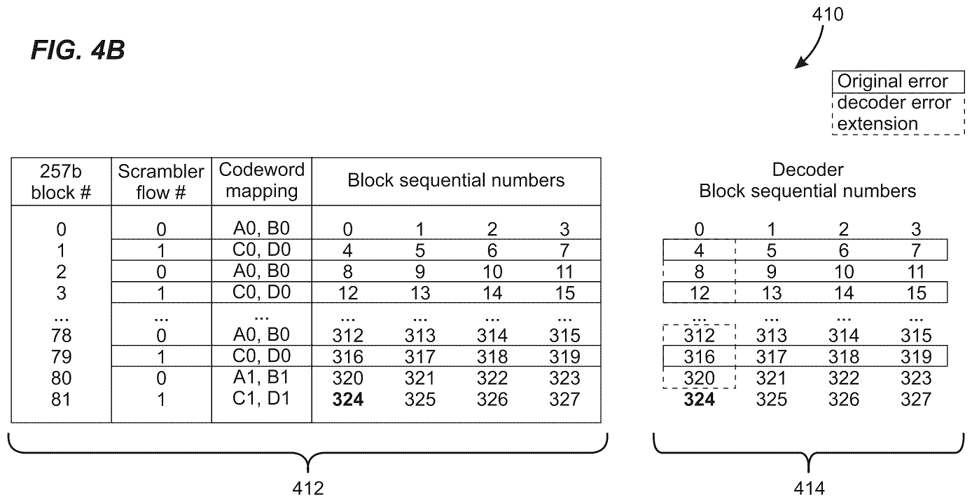

FIGS. 4A-4B illustrate examples of unmarked error scenarios for both 800GBASE-R and 1.6TBASE-R, respectively. More specifically, FIG. 4A illustrates an example 400 of an unmarked error scenario in 800GBASE-R. Consider, for instance, stream data 402 that the stateless decoder processes to form decoded data 404.

As described above, the descrambler multiplication is not covered by the 66b/64b stateless decoder. Thus, if codeword DO is uncorrectable, it will cause the whole content of C0 and D0 to be marked as bad. Worse, if D0 has bit errors in the last 57 bits, the error multiplication of the descrambler will cause an unmarked bit error in the subsequent 257b block (bits from C1), which the stateless decoder does not mark as erroneous.

Similarly, uncorrectable B0 (in 66B block 318) can cause errors in A1 (in 66B block 320), which is not marked as an error by the stateless decoder. However, uncorrectable A0 and C0 cannot cause the same effect in B1 and D1.

The same issue exists in 1.6TBASE-R in that its descrambler multiplication is likewise not covered by the 66b/64b stateless decoder. For instance, example 410 in FIG. 4B shows an unmarked error scenario for 1.6BASE-R. Given stream data 412, it can be seen that if D0 had bit errors in the last 58 bits, the error multiplication of the descrambler will cause an unmarked bit error in the subsequent 257b block (bits from C1), in decoded data 414, which is not marked as error by the stateless decoder. In this case, a similar effect can happen in all codewords.

There are various hazards that are possible when there are errors after FEC decoding. First, if the descrambler-generated bit errors fall within packet data, it will be captured by the MAC. The scrambler can generate one or two bit errors following the original one. In addition, CRC32 will detect any 2-bit error in a packet. ⋅ This may be considered “unclean” but there is no risk of data corruption (assuming the Ethernet MAC is used).

But, if bit errors fall within control blocks, packets can be merged or truncated and data can potentially be corrupted. Specifically, the 4-bit hamming distance encoding of the “Block Type Field” in the first control block is lost in the transcoding.

Also, an error in the first bit of the 257b block can turn a data block into a control block. The state-diagram decoder offers sufficient protection by requiring an IPG before a “start” block.

Bit 0 (block type) is the most important with respect to the hazards of unmarked errors. This is because if this bit is flipped from 0 to 1, it causes a control/data block to become a data block. In normal traffic this could cause packet merging. However, if this is after error blocks, this is not possible and there is no hazard in this case.

If the block type bit 0 is flipped from 1 to 0, it causes a data block to become a control/data block. Then, bits 1-4 will be interpreted as the data/control type of the four 66-bit blocks. Here, 0 means control. If the next four bits are 0111, data corruption is possible. If this bit was originally 1 and is unchanged, there is no FPA hazard, as the whole block is data protected by CRC32. If this bit was originally 0 and is unchanged, a FPA event is likely impossible. Strange events like two consecutive “start” blocks can occur, but with low probability.

A false start-of-packet can be created under the following conditions:
A 257b block consisting of only data (bit 0 is 1)
Bit 0 of the 257b block is flipped from 1 to 0 (indicating some control/data block)
Bits 1-4 of the 257b block were originally 0111 (interpreted as if the first 66b block is a control block)
Bits 5-8 of the 257b block were originally also 0111 (interpreted as if the “f_0” field is 0x7, encoding an/S/as the first character)

In total, this event requires a specific bit flip and specific 8 bits being 0x77 in the data stream.

A false start-of-packet can have the following effects:
With a stateless decoder, a false start-of-packet in the middle of the data stream creates a “front-truncated” packet, whereby the beginning is lost.
The CRC32 does not have a guaranteed performance for a truncated packet and has a probability of 2⁻³²≈2-10 to match.
If the CRC matches, the MAC falsely accepts a corrupted packet (FPA).
There may be other safety nets (e.g., addresses, EtherType, etc. are usually checked), but we will only look at CRC, as is typically done in meant time to false packet acceptance (MTTFPA) calculations.

With respect to the probability of a codeword error leading to an FPA event:
The codeword error ratio required by Ethernet is <1.45e-11 (174A.5)
   This does not include xMII extenders which can slightly increase the total ratio.
Given an uncorrectable codeword, there are at least 16-bit errors in the 5140-bit payload. Consider 2 extreme scenarios for the number of bit errors N:
   N=16 (minimum, best case)
   N=2570 (major burst with BER=0.5, worst case)
Assume the location of the errors within the codeword is distributed uniformly
With descrambler multiplication, there are 2 specific locations where errors can cause a flip of bit 0 of the next codeword
   The probability of an error happening in one location is 16/5140≈3e-3 (best case) or 0.5 (worst case)
   The probability of an error in either location is ~6e-3 (best case) or 0.75 (worst case)
The probability that bit 0 of a codeword was 1 (all-data block) depends on the traffic pattern
   With large packets and high link utilization, it is close to 1, so assume it is 1
The probability that bits 1-8 are 0x77, assuming random data, is 1/256≈~4e-3
The probability of CRC32 escape is ~2e-10
Thus, for 1.6GBASE-R:
   In scenario A, an FPA will happen in at most 1.45e-11*6e-3*4e-3*2e-10 of the codewords; calculation yields 8e-26
   In scenario B, an FPA will happen in at most 1.45e-11*0.75*4e-3*2e-10 of the codewords; calculation yields 1e-23.
In 800G the problem can only occur with uncorrectable codewords B or D, so there is an additional factor of 0.5

The table below shows the worst case MTTFPA for both data rates:

TABLE 1

| | Codeword | MTTFPA, | | MTTFPA, |
|---|---|---|---|---|
| Data Rate | Time | Scenario A | | Scenario B |
| 800GBASE-R | 6.4 ns | 5 | billion years | 40 million years |
| 1.6TBASE-R | 6.4 ns | 1.2 | billion years | 10 million years |

To address the above challenges, one approach herein would be to use the state-diagram decoder used in prior PCS specifications, in some implementations. However, this is a complex decoder that does not support advanced features such as UEC control ordered sets, which will likely be needed by future applications.

Alternatively, in further implementations, the decoder can be changed to mark more than one additional block as error (i.e., by leveraging an increased “block memory”). In doing so:
For 800GBASE-R, extending the marking to at least two blocks solves the problem.
For 1.6TBASE-R, the marking needs to be extended to at least five blocks.

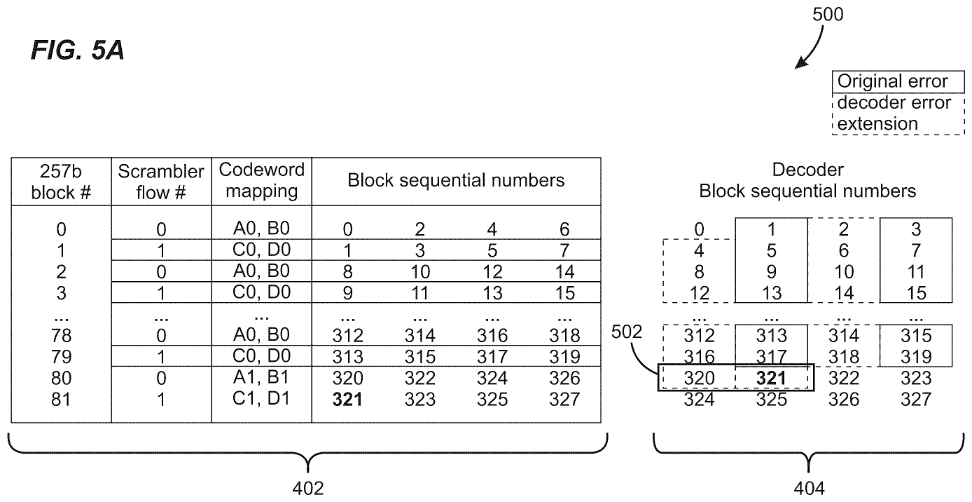

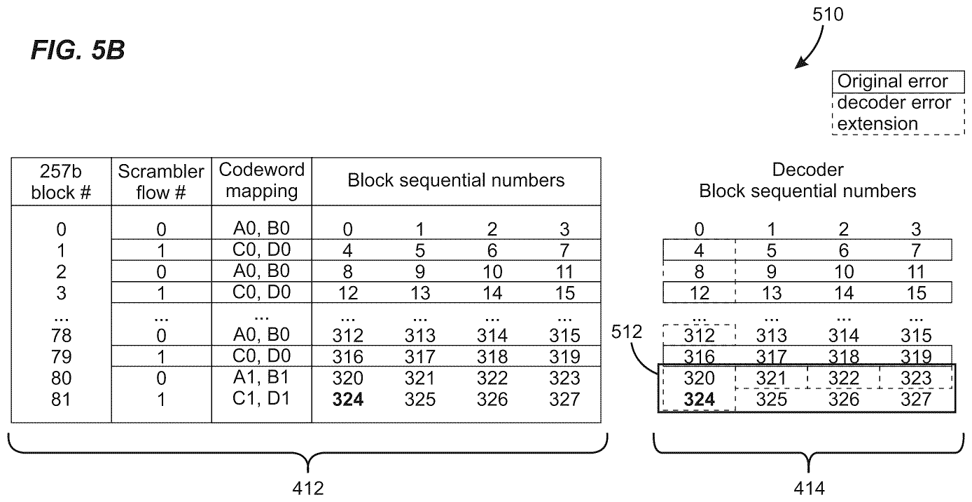

The effects of doing so are shown in FIGS. 5A-5B, according to various implementations. Continuing the examples of FIGS. 4A-4B, example 500 in FIG. 5A shows the use of a longer error extension (e.g., two blocks instead of one) in the case of 800GBASE-R. Similar to FIG. 4A, if codeword DO is uncorrectable, it will cause the whole contents of C0 and D0 to be marked as bad. Instead, in various implementations, the longer error extension 502 causes the single block that may include descrambler-multiplied bit errors to be discarded. This is because the subsequent block is more than 58 bits away and beyond the range of descrambler errors.

Variations on the techniques herein (such as marking within the 257b transcoding function) can be used as long as any block that can be affected by descrambler error multiplication is marked, in further implementations.

FIG. 5B illustrates an example 510 that addresses the scenario introduced in FIG. 4B with respect to 1.6TBASE-R. As a reminder, if codeword DO is uncorrectable, it will cause the whole content of C0 and D0 to be marked as bad. In various implementations, the decoder may use a longer memory 512 than in the case of 800GBASE-R to discard the block that includes the descrambler-multiplied bit errors.

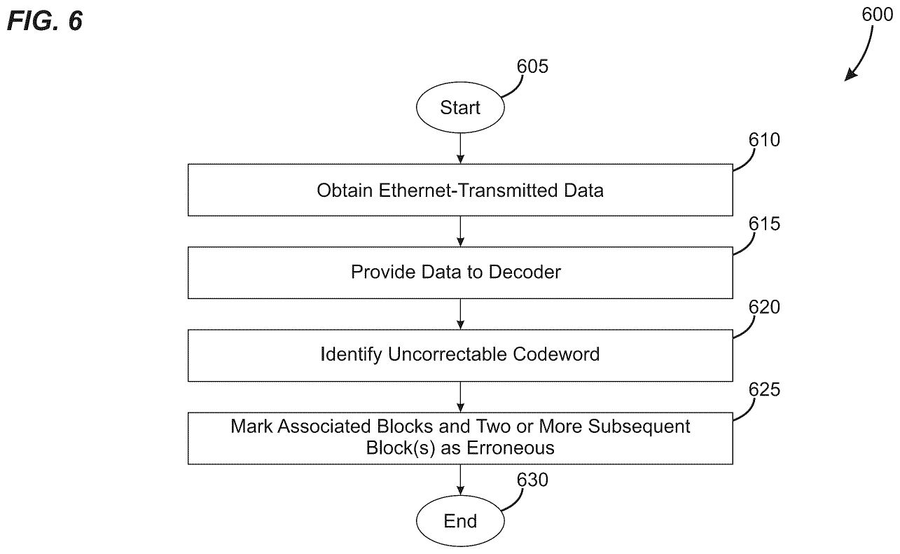

FIG. 6 illustrates an example procedure for protecting against data corruption in high-speed Ethernet, in accordance with one or more implementations described herein. For example, a non-generic, specifically configured device (e.g., device 200, such as a network switch), may perform procedure 600 (e.g., a method) by executing stored instructions (e.g., communication process 248). The procedure 600 may start at step 605, and continues to step 610, where, as described in greater detail above, the device (e.g., a controller, processor, etc.) may obtain Ethernet-transmitted data. In some instances, the Ethernet-transmitted data comprises two flows of data transmitted by a sender. In one implementation, the Ethernet-transmitted data is sent according to 800GBASE-R. In a further implementation, the Ethernet-transmitted data is sent according to 1.6TBASE-R.

At step 615, as detailed above, the device may provide the Ethernet-transmitted data to a decoder. For instance, in some implementations, the decoder may be a Reed-Solomon decoder.

At step 620, the device may identify, using the decoder, an uncorrectable codeword in the Ethernet-transmitted data, as described in greater detail above.

At step 625, as detailed above, the device may mark, using the decoder, all blocks in the Ethernet-transmitted data associated with the uncorrectable codeword and two or more subsequent blocks in the Ethernet-transmitted data as erroneous. In some implementations, the two or more subsequent blocks is a set of two subsequent blocks, such as when the data is sent according to 800GBASE-R. In further implementations, the two or more subsequent blocks is a set of five subsequent blocks, such as when the data is sent according to 1.6TBASE-R. In some instances, those blocks in the Ethernet-transmitted data associated with the uncorrectable codeword include a flipped bit that changes a data block to being a control block. In one implementation, the device may discard the block associated with the uncorrectable codeword. The device may also use a cyclical redundancy check to identify a corrupted bit that is subsequent to the two or more subsequent blocks, in some implementations.

Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative embodiments for protecting against data corruption in high-bandwidth Ethernet, it is to be understood that various other adaptations and modifications may be made within the intent and scope of the embodiments herein. For instance, while the techniques herein are primarily described with respect to an Ethernet ring, the techniques herein are not limited as such and can be applied to any form of communication network that uses a ring topology.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
obtaining, by a device, Ethernet-transmitted data;
providing, by the device, the Ethernet-transmitted data to a decoder;
identifying, by the device and using the decoder, an uncorrectable codeword in the Ethernet-transmitted data; and
marking, by the device and using the decoder, all blocks in the Ethernet-transmitted data associated with the uncorrectable codeword and two or more subsequent blocks in the Ethernet-transmitted data as erroneous.

2. The method as in claim 1, wherein the Ethernet-transmitted data comprises two flows of data transmitted by a sender.

3. The method as in claim 1, wherein the Ethernet-transmitted data is sent according to 800GBASE-R.

4. The method as in claim 3, wherein the two or more subsequent blocks is a set of two subsequent blocks.

5. The method as in claim 1, wherein the Ethernet-transmitted data is sent according to 1.6TBASE-R.

6. The method as in claim 5, wherein the two or more subsequent blocks is a set of five subsequent blocks.

7. The method as in claim 1, wherein those blocks in the Ethernet-transmitted data associated with the uncorrectable codeword include a flipped bit that changes a data block to being a control block.

8. The method as in claim 1, further comprising:
discarding all blocks associated with the uncorrectable codeword.

9. The method as in claim 8, further comprising:
using a cyclical redundancy check to identify a corrupted bit that is subsequent to the two or more subsequent blocks.

10. The method as in claim 1, wherein the decoder is a Reed-Solomon decoder.

11. An apparatus, comprising:
one or more network interfaces;
a processor coupled to the one or more network interfaces and configured to execute one or more processes; and
a memory configured to store a process that is executable by the processor, the process when executed configured to:
obtain Ethernet-transmitted data;
provide the Ethernet-transmitted data to a decoder;
identify, using the decoder, an uncorrectable codeword in the Ethernet-transmitted data; and
mark, using the decoder, all blocks in the Ethernet-transmitted data associated with the uncorrectable codeword and two or more subsequent blocks in the Ethernet-transmitted data as erroneous.

12. The apparatus as in claim 11, wherein the Ethernet-transmitted data comprises two flows of data transmitted by a sender.

13. The apparatus as in claim 11, wherein the Ethernet-transmitted data is sent according to 800GBASE-R.

14. The apparatus as in claim 13, wherein the two or more subsequent blocks is a set of two subsequent blocks.

15. The apparatus as in claim 11, wherein the Ethernet-transmitted data is sent according to 1.6TBASE-R.

16. The apparatus as in claim 15, wherein the two or more subsequent blocks is a set of five subsequent blocks.

17. The apparatus as in claim 11, wherein those blocks in the Ethernet-transmitted data associated with the uncorrectable codeword include a flipped bit that changes a data block to being a control block.

18. The apparatus as in claim 11, wherein the process when executed is further configured to:
discard all blocks associated with the uncorrectable codeword.

19. The apparatus as in claim 18, wherein the process when executed is further configured to:
use a cyclical redundancy check to identify a corrupted bit that is subsequent to the two or more subsequent blocks.

20. A tangible, non-transitory, computer-readable medium storing program instructions that cause a device to execute a process comprising:
obtaining, by the device, Ethernet-transmitted data;
providing, by the device, the Ethernet-transmitted data to a decoder;
identifying, by the device and using the decoder, an uncorrectable codeword in the Ethernet-transmitted data; and
marking, by the device and using the decoder, all blocks in the Ethernet-transmitted data associated with the uncorrectable codeword and two or more subsequent blocks in the Ethernet-transmitted data as erroneous.
